(19) United States
(12) Patent Application Publication
(10) Pub. No.: US 2009/0205176 A1
(43) Pub. Date: Aug. 20, 2009

(54) METHOD FOR MANUFACTURING A LIQUID JET HEAD AND A METHOD FOR MANUFACTURING AN ACTUATOR APPARATUS

(75) Inventor: Akira Kuriki, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/350,791

(22) Filed: Jan. 8, 2009

(30) Foreign Application Priority Data
Jan. 10, 2008 (JP) 2008-003666

(51) Int. Cl. H04R 17/00; B23P 17/00

(52) U.S. Cl. 29/25.35; 29/890.1

(57) ABSTRACT

In order to improve reliability, there are provided a step of forming lower electrode 60 above the surface of a passage forming substrate wafer 110 and a step of forming a piezoelectric layer 70 including a plurality of piezoelectric films 75 above the lower electrode 60 by repeatedly performing a process of forming piezoelectric film 75 in a manner of forming a piezoelectric precursor film and sintering the piezoelectric precursor film. In the step of forming the piezoelectric layer, a temperature of the piezoelectric film 75 is dropped at a temperature drop speed of 25° C./sec or less by 100° C. from a temperature at which the piezoelectric precursor film is sintered, after the piezoelectric precursor film is sintered.

### BACKGROUND

1. Technical Field

The present invention relates to a method of manufacturing an actuator including a piezoelectric element which has a lower electrode, a piezoelectric layer, and an upper electrode and is provided so as to be displaceable on a substrate and a method of manufacturing a liquid jet head including the actuator as liquid jet means.

2. Related Art

The piezoelectric element used for the actuator is formed such that the piezoelectric layer made of a piezoelectric material having an electro-mechanical transduction function, such as lead zirconate titanate as a crystallized dielectric material, is interposed between two electrodes, that is, the lower electrode and the upper electrode. This actuator is generally called a bent vibration mode actuator. For example, this actuator is mounted on a liquid jet head.

As a representative example of the liquid jet head, there is known an ink jet print head in which a part of a pressure generating chamber communicating with a nozzle opening for ejecting an ink droplet is configured as a vibration plate and the ink droplet is ejected from the nozzle opening by allowing the piezoelectric element to deform the vibration plate and pressurizing ink of the pressure generating chamber.

In the piezoelectric layer (piezoelectric film), ferroelectric such as lead zirconate titanate (PZT) is used. For example, the piezoelectric layer is formed as follows. First, a piezoelectric precursor film as a first layer is formed on the lower electrode by a sol-gel method and the piezoelectric precursor film is baked and crystallized to form the piezoelectric film. Then, the piezoelectric films are sequentially laminated to form the piezoelectric layer having a predetermined thickness (for example, JP-A-2006-306709).

However, when the piezoelectric film is baked and the temperature of the piezoelectric film is rapidly dropped, abnormal stress occurs in the piezoelectric layer, thereby causing crack in the piezoelectric layer. Moreover, since the crystallization of the piezoelectric layer is not good, a problem may occur consequently in that various characteristics such as a displacement characteristic of the piezoelectric element and durability deteriorate.

This problem occurs not only in the piezoelectric element mounted on the ink jet print head but also in the piezoelectric element mounted on other liquid jet heads.

The invention is devised in view of the above-mentioned circumstance and an object of the invention is to provide a method of manufacturing a liquid jet head and a method of manufacturing an actuator so as to improve reliability.

### SUMMARY

In order to solve the above-mentioned problems, according to an aspect of the invention, there is provided a method of manufacturing a liquid jet head which includes a passage forming substrate provided with a pressure generating chamber communicating with a nozzle opening for ejecting a liquid and a piezoelectric element applying pressure to the pressure generating chamber for ejecting the liquid. The method includes the steps of: forming lower electrode above the passage forming substrate; forming a piezoelectric layer including a plurality of piezoelectric films above the lower electrode, by repeatedly performing a piezoelectric film forming process of forming a piezoelectric precursor film, which contains a ferroelectric material having a perovskite structure, and sinter to crystallize the piezoelectric precursor film; and forming an upper electrode above the piezoelectric layer to form an piezoelectric element which includes the lower electrode, the piezoelectric layer, and the upper electrode. In the step of forming the piezoelectric layer, a temperature of the piezoelectric film is dropped at a temperature drop speed of 25° C./sec or less by 100° C. from a temperature at which the piezoelectric precursor film is sintered, after the piezoelectric precursor film is sintered.

In the method according to this aspect, the temperature of the piezoelectric film is dropped at the temperature drop speed of 25° C./sec or less, after the piezoelectric precursor film is sintered and the piezoelectric film is formed. Therefore, the piezoelectric element including the piezoelectric layer having satisfactory crystallization can be formed without crack which is caused due to stress. Since the piezoelectric element is excellent in a displacement characteristic and durability, a liquid jet head is excellent in a liquid ejecting characteristic or durability.

In the step of forming the piezoelectric layer, it is preferable that the piezoelectric layer is formed by forming a first piezoelectric film, dropping the temperature of the first piezoelectric film at the temperature drop speed, simultaneously patterning the lower electrode and the first piezoelectric film, and then sequentially laminating the piezoelectric films above the passage forming substrate including the patterned first piezoelectric film. Accordingly, it is possible to form the piezoelectric layer having more satisfactory crystallization.

According to another aspect of the invention, there is provided a method of manufacturing an actuator comprising the steps of: forming a lower electrode above a substrate; forming a piezoelectric layer including a plurality of piezoelectric films above the lower electrode, by repeatedly performing a piezoelectric film forming process of forming a piezoelectric precursor film, which contains a ferroelectric material having a perovskite structure, and sinter to crystallize the piezoelectric precursor film; and forming an upper electrode above the piezoelectric layer to form an piezoelectric element which includes the lower electrode, the piezoelectric layer, and the upper electrode. In the step of forming the piezoelectric layer, a temperature of the piezoelectric film is dropped at a temperature drop speed of 25° C./sec or less by 100° C. from a temperature at which the piezoelectric precursor film is sintered, after the piezoelectric precursor film is sintered.

In the method according to this aspect, the temperature of the piezoelectric film is dropped at the temperature drop speed of 25° C./sec or less, after the piezoelectric precursor film is sintered and the piezoelectric film is formed. Therefore, the actuator including the piezoelectric layer having satisfactory crystallization can be formed without crack which is caused due to stress. The actuator is excellent in a displacement characteristic and durability.

### BRIEF DESCRIPTION OF THE DRAWINGS

FIG. 1 is an exploded perspective view illustrating the overall configuration of a print head according to a first embodiment.

FIG. 2 is a top view and a sectional view illustrating the print head according to the first embodiment.

FIG. 3 is a sectional view illustrating a method of manufacturing the print head according to the first embodiment.

FIG. 4 is a sectional view illustrating the method of manufacturing the print head according to the first embodiment.

FIG. 5 is a sectional view illustrating method of manufacturing the print head according to the first embodiment.

FIG. 6 is a sectional view illustrating the method of manufacturing the print head according to the first embodiment.

FIG. 7 is a sectional view illustrating the method of manufacturing the print head according to the first embodiment.

FIG. 8 is a sectional view illustrating the method of manufacturing the print head according to the first embodiment.

10: PASSAGE FORMING SUBSTRATE
12: PRESSURE GENERATING CHAMBER
13: COMMUNICATION SECTION
14: INK SUPPLY PASSAGE
20: NOZZLE PLATE
21: NOZZLE OPENING
30: PROTECTIVE SUBSTRATE
31: RESERVOIR SECTION
32: PIEZOELECTRIC ELEMENT PRESERVER
40: COMPLIANCE SUBSTRATE
60: LOWER ELECTRODE
61: SEED TITANIUM LAYER
62: INTERMEDIATE TITANIUM LAYER
70: PIEZOELECTRIC LAYER
74: PIEZOELECTRIC PRECURSOR FILM
75: PIEZOELECTRIC FILM
80: UPPER ELECTRODE FILM
90: LEAD ELECTRODE
100: RESERVOIR
120: DRIVING CIRCUIT
121: CONNECTION WIRING
300: PIEZOELECTRIC ELEMENT

### DESCRIPTION OF EXEMPLARY EMBODIMENTS

Hereinafter, an embodiment of the invention will be described in detail.

### First Embodiment

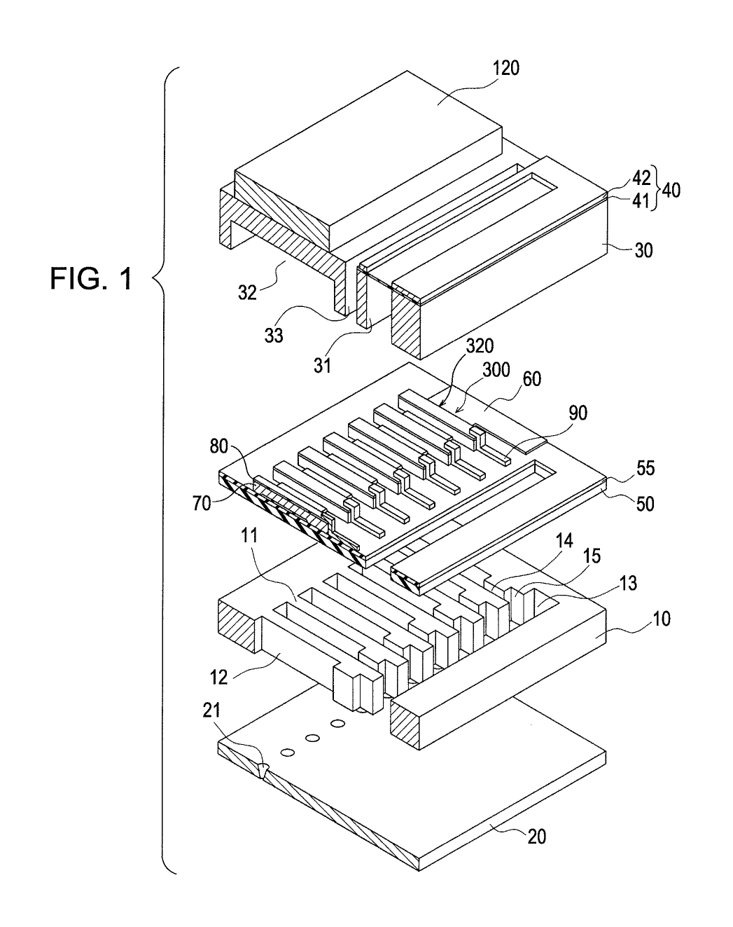

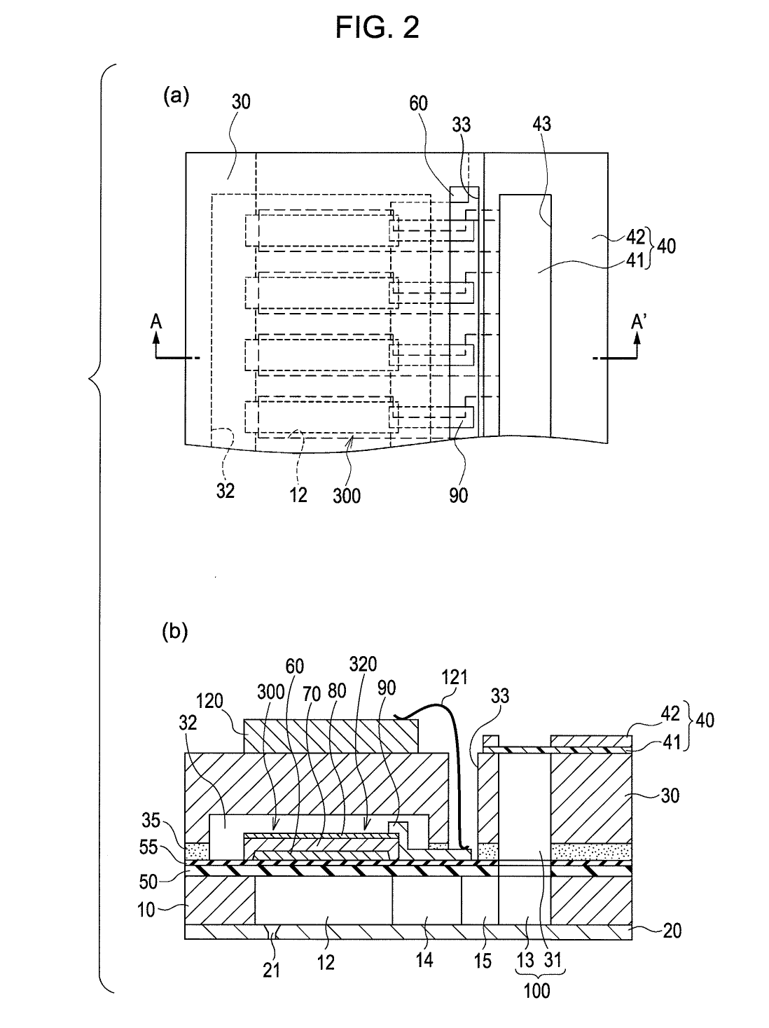

FIG. 1 is an exploded perspective view illustrating the overall configuration of an ink jet print head as an example of a liquid jet head according to a first embodiment of the invention. FIG. 2 is a top view and a sectional view taken along the line A-A′ of FIG. 1.

As illustrated, a passage forming substrate 10 is formed of a silicon single crystal substrate having face orientation (110) according to this embodiment. In addition, an elastic film 50 formed of silicon dioxide by thermal oxidation and having a thickness in the range of 0.5 to 2 μm is formed in advance on one surface of the passage forming substrate.

Pressure generating chambers 12 partitioned by a plurality of partition walls 11 are arranged in parallel in the passage forming substrate 10 in the width direction (transverse direction) by anisotropic etching from the other surface of the passage forming substrate. Ink supply passages 14 (liquid supply passages) and communication passages 15 are partitioned by the partition walls 11 in one ends in a longitudinal direction of the pressure generating chambers 12 of the passage forming substrate 10. A communication section 13 forming a part of a reservoir 100 as a common ink chamber (liquid chamber) of the pressure generating chambers 12 is formed in one ends of the communication passages 15. That is, the passage forming substrate 10 is provided with a liquid passage including the pressure generating chambers 12, the communication section 13, and the ink supply passages 14, and the communication passages 15.

Each of the ink supply passages 14 communicates with one end in the longitudinal direction of the pressure generating chamber 12 and has a cross-section area smaller than that of the pressure generating chamber 12. For example, in this embodiment, the width of the ink supply passage 14 is formed to be smaller than the width of the pressure generating chamber 12 by narrowing a passage in the width direction on a side of the pressure generating chamber 12 between the reservoir 100 and the pressure generating chamber 12. In this embodiment, the ink supply passage 14 is formed by narrowing the width of the passage on one side, but the ink supply passage may be formed by narrowing the width of the passage on both sides. Alternatively, the ink supply passage may be formed not by narrowing the width of the passage but by narrowing the passage in the thickness direction. Each of communication passages 15 communicates with a side opposite the pressure generating chamber 12 of the ink supply passage 14 and has a cross-section area larger than that of the ink supply passage in the width direction (transverse direction) of the ink supply passage 14. In this embodiment, the communication passage 15 has the same cross-section area as that of the pressure generating chamber 12.

That is, in the passage forming substrate 10, the pressure generating chambers 12, the ink supply passages 14 having the cross-section area smaller than the cross-section area of the pressure generating chamber 12 in the transverse direction, the communication passages 15 individually communicating with the ink supply passages 14 and having the cross-section area larger than the cross-section area of the ink supply passage 14 in the transverse direction are partitioned by the plurality of partition walls 11.

A nozzle plate 20 through which nozzle openings 21 individually communicating with the vicinities of the ends opposite the ink supply passages 14 of the pressure generating chambers 12 are punched is fixed and adhered to an opening surface of the passage forming substrate 10 by an adhesive 35 or a heat welding film. The nozzle plate 20 is formed of glass ceramics, a silicon single crystal substrate, stainless steel, or the like.

On the other hand, the elastic film 50 is formed opposite the opening surface of the passage forming substrate 10, as described above, and an insulating film 55 is formed on the elastic film 50. Piezoelectric elements 300 each including a lower electrode film 60, a piezoelectric layer 70, and an upper electrode film 80 are formed on the insulating film 55 by a process described below. Here, the piezoelectric element 300 is a portion containing the lower electrode film 60, the piezoelectric layer 70, and the upper electrode film 80. In general, one electrode in the piezoelectric element 300 serves as a common electrode, and the other electrode and the piezoelectric layer 70 are formed by patterning each of the pressure generating chambers 12. Here, the piezoelectric element includes any one electrode thereof and the piezoelectric layer 70 which have been patterned and a portion in which piezoelectric deformation occurs due to application of voltage to the both electrodes is referred to as a piezoelectric active portion 320. In this embodiment, the lower electrode film 60 serves as a common electrode of the piezoelectric element 300 and the upper electrode film 80 serves as an individual electrode of the piezoelectric element 300. However, the reverse configuration is also possible depending on the restriction condition on a driving circuit or wirings. Here, each of the piezoelectric elements 300 and all vibration plates to be displaced due to drive of the piezoelectric elements 300 are referred to as an actuator. In this embodiment, the elastic film 50, the insulating film 55, and the lower electrode film 60 serve as the vibration plate. Of course, the invention is not limited thereto. For example, only the lower electrode film 60 may serve as the vibration plate without providing the elastic film 50 and the insulating film 55. Alternatively, the piezoelectric elements 300 may practically serve as the vibration plate.

The piezoelectric layer 70 formed above the lower electrode film 60 is made of a piezoelectric material having an electro-mechanical conversion feature, and particularly made of a ferroelectric material having a perovskite structure among piezoelectric materials. It is preferable that the piezoelectric layer 70 is formed of a crystallization film having the perovskite structure. For example, the ferroelectric material such as lead zirconate titanate (PZT) or a material formed by adding metal oxide such as niobium oxide, nickel oxide, or magnesium oxide to lead zirconate titanate is suitable for the material of the piezoelectric layer. Specifically, lead titanate (PbTiO3), lead zirconate titanate (Pb(Zr, Ti)O3), lead zirconate acid (PbZrO3), lead lanthanum titanate ((Pb, La), TiO3), lead lanthanum zirconate titanate ((Pb, La)(Zr, Ti)O3), lead magnesium niobate zirconate titanate (Pb(Zr, Ti)(Mg, Nb)O3), or like can be used.

A lead electrode 90 which is drawn from the vicinity of the end of the ink supply passage 14 and extends up to the insulating film 55 and which is made of gold (Au), for example, is connected to each of the upper electrode film 80 as an individual electrode of the piezoelectric element 300.

A protective substrate 30 having a reservoir section 31 forming at least a part of the reservoir 100 is joined to the passage forming substrate 10 provided with the piezoelectric elements 300, that is, to the lower electrode film 60, the elastic film 50, and the lead electrodes 90 through the adhesive 35. In this embodiment, the reservoir section 31 is perforated through the protective substrate 30 in the thickness direction and formed in the width direction of the pressure generating chambers 12. In addition, as described above, the reservoir section communicates with the communication section 13 of the passage forming substrate 10 to form the reservoir 100 as a common ink chamber of the pressure generating chambers 12. Only the reservoir section 31 may be configured to serve as a reservoir by partitioning the communication section 13 of the passage forming substrate 10 in every pressure generating chamber 12. Alternatively, only the pressure generating chambers 12 are provided in the passage forming substrate 10 and the ink supply passage 14 communicating with the reservoir and the pressure generating chambers 12 may be formed in members (for example, the elastic film 50, the insulating film 55, and the like) interposed between the passage forming substrate 10 and the protective substrate 30.

Piezoelectric element preservers 32 each ensuring a space so as not to interrupt the movement of the piezoelectric element 300 are formed in an area opposite the piezoelectric element 300 of the protective substrate 30. Each of the piezoelectric element preservers 32 has the space so as not to interrupt the movement of the piezoelectric element 300. In addition, the space may be airtightly sealed or not sealed.

It is preferable that the protective substrate 30 is made of a material such as glass or a ceramic material having the substantially same thermal expansibility as that of the passage forming substrate 10. In this embodiment, the protective substrate is formed of a silicon single crystal substrate which is the same material as that of the passage forming substrate 10.

A through-hole 33 perforated through the protective substrate 30 in the thickness direction is formed in the protective substrate 30. The lead electrodes 90 are drawn from the piezoelectric elements 300, respectively, so that the vicinities of the ends thereof are exposed in the through-hole 33.

A driving circuit 120 for driving the piezoelectric elements 300 arranged in parallel is fixed onto the protective substrate 30. The driving circuit 120 can be formed of a circuit substrate or a semiconductor integrated circuit (IC), for example. The driving circuit 120 and the lead electrodes 90 are electrically connected to each other through connection wirings 121 formed of a conductive wire such as a bonding wire.

A compliance substrate 40 including a sealing film 41 and a fixing plate 42 is joined onto the protective substrate 30. The sealing film 41 is made of a material (for example, a polyphenylene sulfide (PPS) film) having a low rigidity and a flexible property. One surface of the reservoir section 31 is sealed by the sealing film 41. The fixing plate 42 is made of a material (for example, stainless steel (SUS)) such as metal having a hard property. Since an area opposite the reservoir 100 of the fixing plate 42 is an opening 43 completely removed in the thickness direction, one surface of the reservoir 100 is sealed only by the sealing film 41 having a flexible property.

In the ink jet print head according to this embodiment, ink is supplied from an ink introduction port connected to external ink supplying means (not shown), the inside from the reservoir 100 to the nozzle openings 21 is filled with the ink, and ink droplets are ejected from the nozzle openings 21 by applying voltage between the lower electrode film 60 and the upper electrode film 80 corresponding to each of the pressure generating chambers 12 in accordance with a print signal supplied from the driving circuit 120, deforming the elastic film 50, the insulating film 55, the lower electrode film 60, and the piezoelectric layer 70 so as to be bent, and increasing the pressure of each of the pressure generating chambers 12.

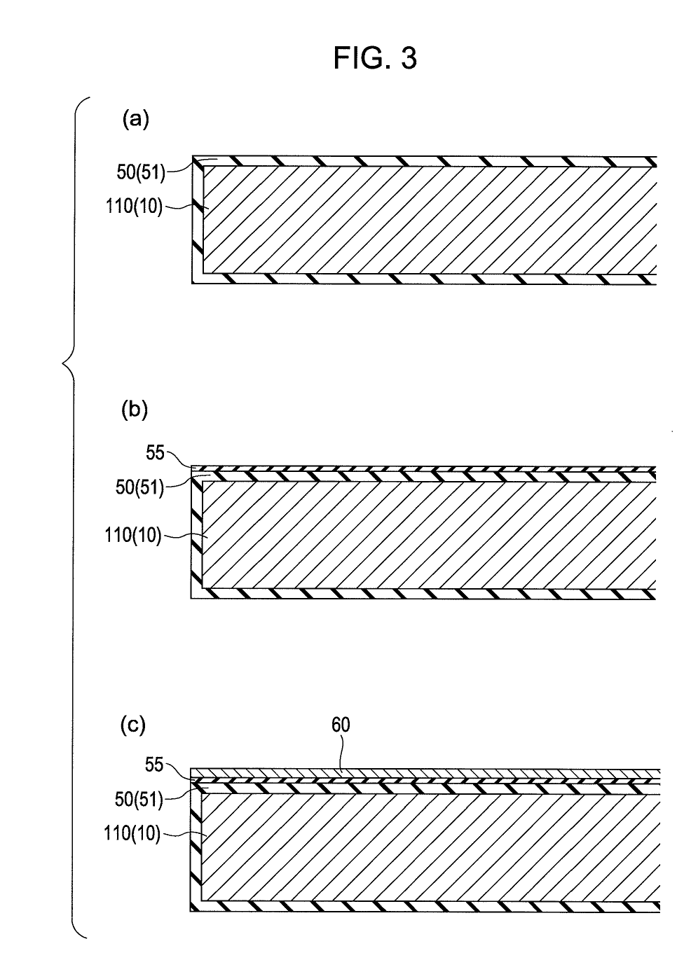

Hereinafter, a method of manufacturing the ink jet print head will be descried with reference to FIGS. 3 to 8. FIGS. 3 to 8 are sectional views illustrating the pressure generating chamber in a longitudinal direction in order to describe the method of manufacturing the ink jet print head as an example of the liquid jet head according to the first embodiment of the invention. First, as shown in (a) of FIG. 3, a silicon dioxide film 51 made of silicon dioxide (SiO2) and forming the elastic film 50 is formed on the surface of a passage forming substrate wafer 110 as a silicon wafer.

Subsequently, as shown in (b) of FIG. 3, the insulating film 55 made of zirconium oxide is formed on the elastic film 50 (the silicon dioxide film 51).

Subsequently, as shown in (c) of FIG. 3, the low electrode film 60 is alloyed by forming a single platinum (Pt) layer or laminating platinum (Pt) and iridium (Ir) layers.

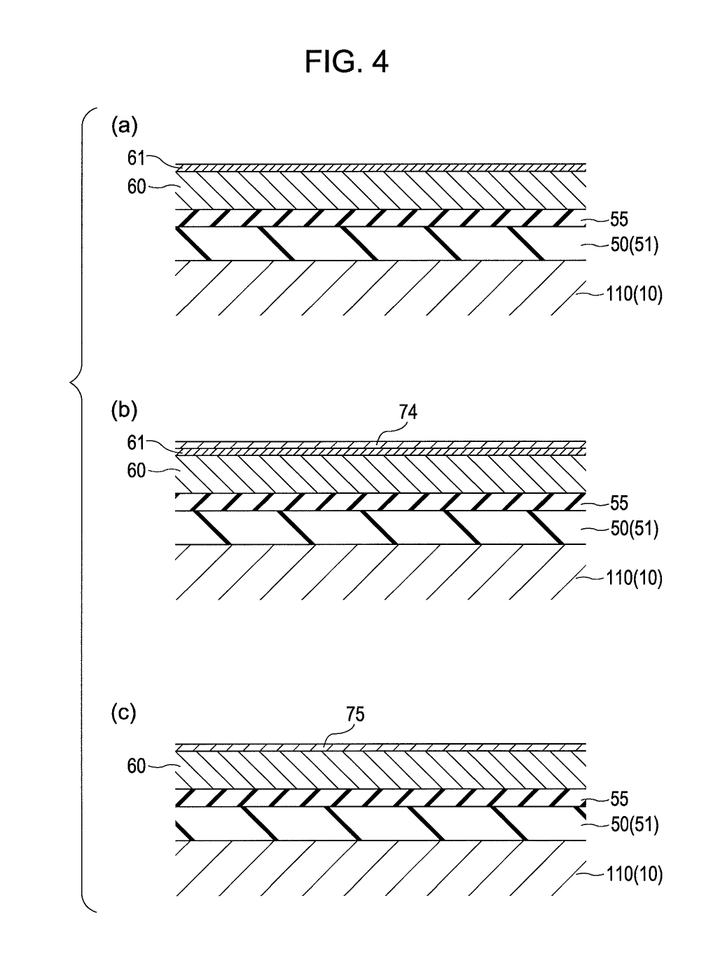

Subsequently, as shown in (a) of FIG. 4, a seed titanium layer 61 made of titanium (Ti) is formed on the lower electrode film 60. By providing the seed titanium layer 61 having a predetermined layer thickness on the lower electrode film 60, a priority alignment direction of the piezoelectric layer 70 can be controlled to (100) or (111) by adjustment of the layer thickness of the piezoelectric layer, when the piezoelectric layer 70 is formed above the lower electrode film 60 with the seed titanium layer 61 interposed therebetween in a subsequent step. Therefore, the piezoelectric layer 70 suitable for an electro-mechanical transduction element can be obtained.

The lower electrode film 60 and the seed titanium layer 61 can be formed by a DC magnetron sputtering method, for example.

Next, the piezoelectric layer 70 made of a ferroelectric material having a perovskite structure is formed. In order to form the piezoelectric layer in this embodiment, there is used a so-called sol-gel method, as a method of forming the piezoelectric layer 70 made of metal oxide, of applying and drying a so-called sol obtained by dissolving and dispersing a metal organic substance with a solvent to make a gel and sintering the gel at a high temperature to obtain the piezoelectric layer 70. The method of the manufacturing the piezoelectric layer 70 is not limited to the sol-gel method, but an MOD (Metal-Organic Decomposition) method may be used.

As a specific sequence of forming the piezoelectric layer 70, a piezoelectric precursor film 74 is first formed on the lower electrode film 60 (the seed titanium layer 61), as shown in (b) of FIG. 4. That is, a sol (solution) containing the ferroelectric material having the perovskite structure is applied onto the passage forming substrate 10 in which the lower electrode film 60 is formed (applying step). Subsequently, the piezoelectric precursor film 74 is heated at a predetermined temperature and dried for certain time (drying step). In this embodiment, for example, the piezoelectric precursor film 74 can be dried while maintaining a temperature from 150 to 170° C. for five to ten minutes.

Subsequently, the dried piezoelectric precursor film 74 is heated at a predetermined temperature to remove fat while maintaining the predetermined temperature (fat-removing step). In this embodiment, for example, the piezoelectric precursor film 74 is heated at a temperature from about 300 to 400° C. to remove the fat, while maintaining the temperature for about five to ten minutes. Here, the fat-removal means that organic components contained in the piezoelectric precursor film 74 are separated into NO2, CO2, H2O, and the like. In addition, in the fat-removing step, it is preferable that a temperature increase rate is 15° C./sec or more.

Subsequently, as shown in (c) of FIG. 4, the piezoelectric precursor film 74 is crystallized by heating the piezoelectric precursor film at a predetermined temperature while maintaining the predetermined temperature for certain time, and a first piezoelectric film 75 is formed (sintering step). In the sintering step according to this embodiment, the piezoelectric precursor film 74 is sintered at a temperature from 680° C. to 800° C. In addition, it is preferable that a temperature increase rate is set in the range of 90 to 110° C./sec.

As a heating apparatus used in the drying step, the fat-removing step, and the sintering step, a hot plate apparatus or an RTP (Rapid Thermal Processing) apparatus performing heating by emission of an infrared lamp can be used, for example.

After the piezoelectric precursor film 74 is sintered to form the first piezoelectric film 75, the temperature of the piezoelectric film 75 is dropped at a temperature drop speed of 25° C./sec or less by 100° C. from the temperature at which the piezoelectric precursor film 74 is sintered. For example, when the piezoelectric precursor film 74 is sintered at 800° C., the temperature drop speed at the time of dropping the temperature from 800° C. to 700° C. is set to 25° C./sec or less. In addition, it is preferable that the temperature drop speed is in the range of 13 to 18° C./sec.

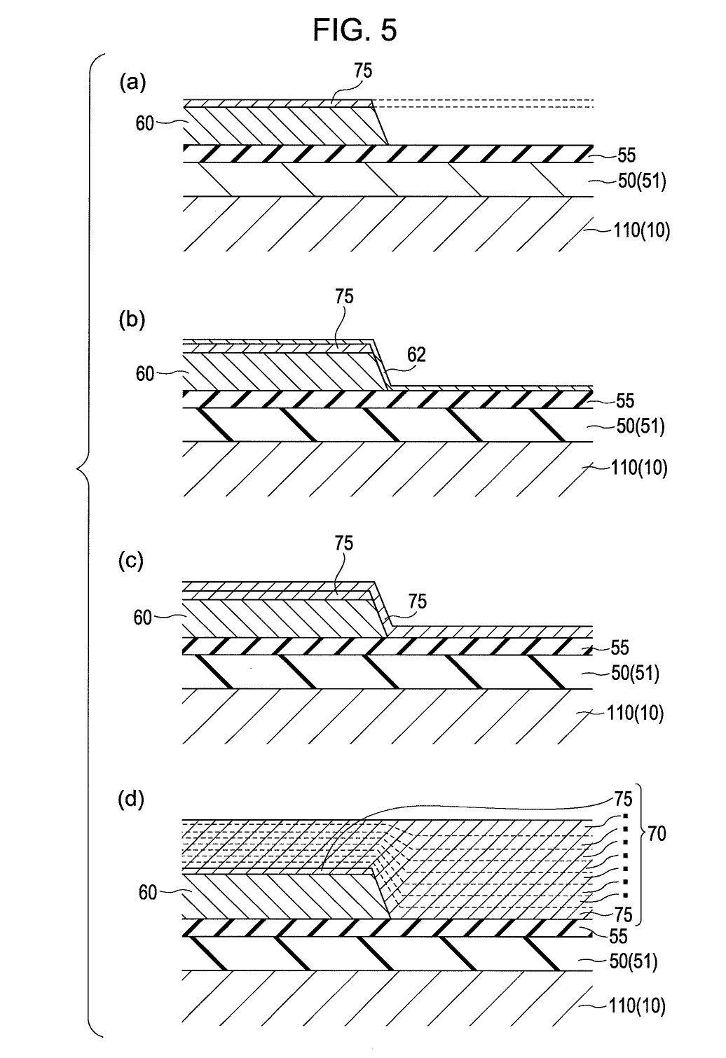

Subsequently, as shown in (a) of FIG. 5, in the step of forming the first piezoelectric film 75 on the lower electrode film 60, the lower electrode film 60 and the first piezoelectric film 75 are patterned so that the side surfaces thereof are inclined. In this case, the patterning on the lower electrode film 60 and the first piezoelectric film 75 may be performed by dry etching such as ion milling.

When the lower electrode film and the first piezoelectric film are together patterned after the formation of the first piezoelectric film 75 above the lower electrode film 60, the piezoelectric layer 70 having better crystallization can be formed, compared to a case where the first piezoelectric film 75 is formed after the lower electrode film 60 is patterned.

Subsequently, as shown in (b) of FIG. 5, an intermediate titanium layer 62 made of titanium (Ti) is again formed on the entire surface of the passage forming substrate wafer 110 including the first piezoelectric film 75. Thereafter, as shown in (c) of FIG. 5, a second piezoelectric film 75 is formed by performing the piezoelectric film forming process including the applying step, the drying step, the fat-removing step, and the sintering step, which are described above. In the sintering step, the piezoelectric precursor film 74 is sintered at the temperature from 680° C. to 800° C., like the first piezoelectric precursor film 74. In addition, it is preferable that the temperature increase rate is set in the range of 90 to 110° C./sec.

Like the first piezoelectric film 75, after a second piezoelectric precursor film 74 is sintered to form the piezoelectric film 75, the temperature of the second piezoelectric film 75 is also dropped at the temperature drop speed of 25° C./sec or less by 100° C. from the temperature at which the second piezoelectric precursor film 74 is sintered.

Subsequently, as shown in (d) of FIG. 5, a plurality of the piezoelectric films 75 (the piezoelectric layer 70) are formed by repeatedly performing the piezoelectric film forming process including the applying step, the drying step, the fat-removing step, and the sintering step on the second piezoelectric film 75. Like the first and second piezoelectric films 75, after third and subsequent piezoelectric precursor films 74 are sintered to form each piezoelectric film 75, the temperature of each piezoelectric film 75 is also dropped at the temperature drop speed of 25° C./sec or less by 100° C. from the temperature at which each piezoelectric precursor film 74 is sintered. That is, by setting a temperature drop condition so as to be the same as that of the sintering step in the plurality of layers, satisfactory crystallization of the piezoelectric layer 70 can be obtained without abnormal stress in the piezoelectric layer 70.

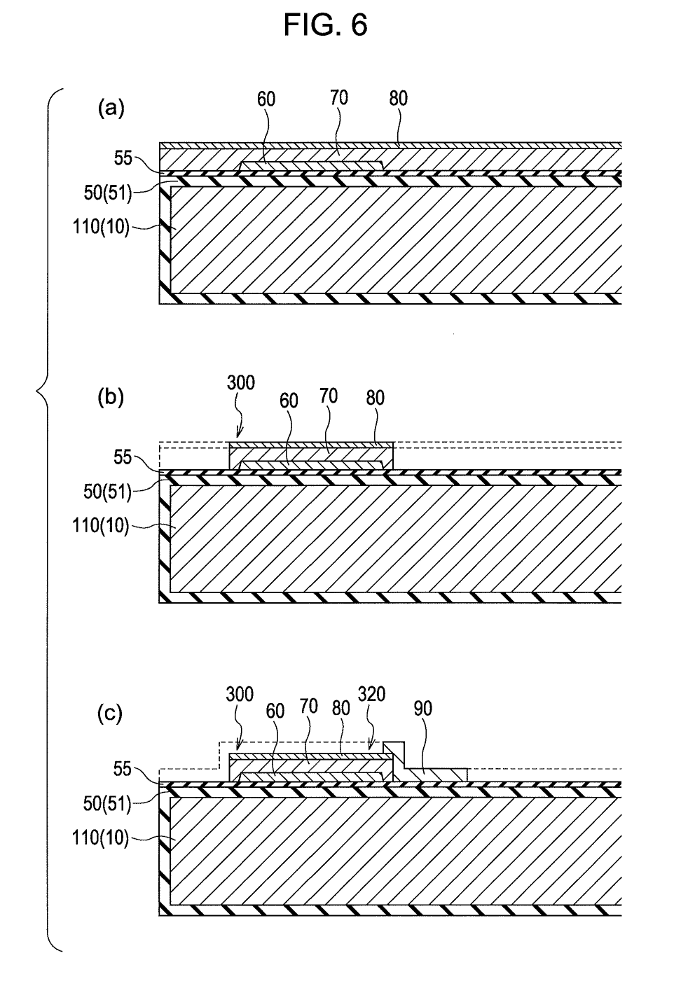

Subsequently, as shown in (a) of FIG. 6, an upper electrode film 80 made of iridium (Ir), for example, is formed across the piezoelectric layer 70.

Subsequently, as shown in (b) of FIG. 6, the piezoelectric layer 70 and the upper electrode film 80 are patterned in an area opposite each of the pressure generating chambers 12 to form each of the piezoelectric elements 300. As a method of patterning the piezoelectric layer 70 and the upper electrode film 80, dry etching such as reactive ion etching or ion milling can be used.

Subsequently, the lead electrodes 90 are formed. Specifically, as shown in (c) of FIG. 6, the lead electrodes 90 made of gold (Au), for example, are formed on the entire surface of the passage forming substrate wafer 110, and then each of the piezoelectric elements 300 are patterned through a master pattern (not shown) including a resist, for example.

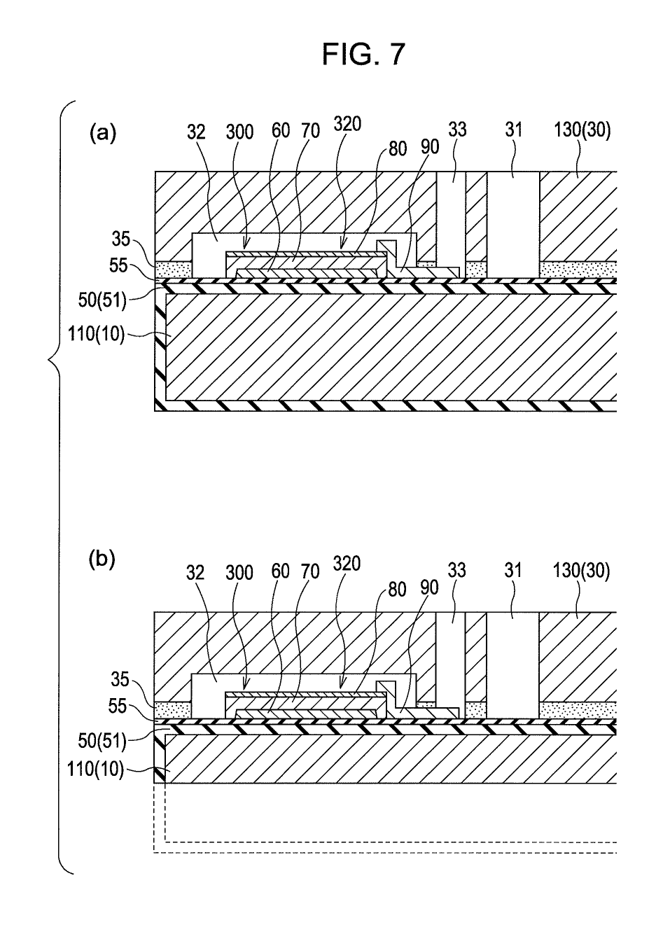

Subsequently, as shown in (a) of FIG. 7, the protective substrate wafer 130 which is a silicon wafer and a plurality of the protective substrates 30 is joined on a side of the piezoelectric elements 300 of the passage forming substrate wafer 110 through the adhesive 35.

Subsequently, as shown in (b) of FIG. 7, the predetermined thickness of the passage forming substrate wafer 110 is made thin.

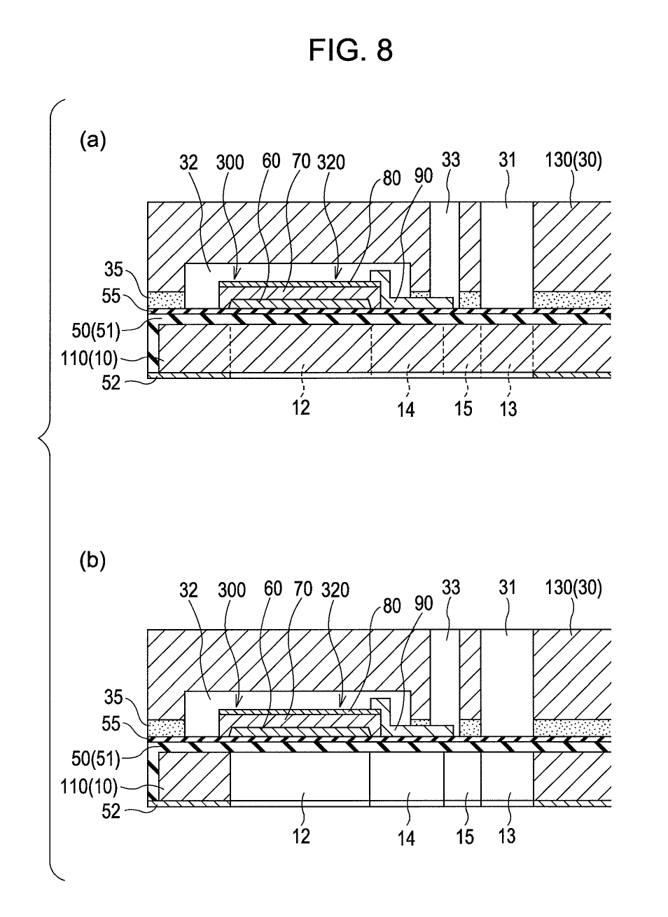

Subsequently, as shown in (a) of FIG. 8, a mask film 52 is newly formed on the passage forming substrate wafer 110 and patterned in a predetermined shape. Subsequently, as shown in (b) of FIG. 8, the pressure generating chambers 12, the communication section 13, the ink supply passages 14, and the communication passage 15 individually corresponding to the piezoelectric elements 300 are formed by allowing the passage forming substrate wafer 110 to be subjected to anisotropic etching (wet etching) by use of an alkali solution such as KOH through the mask film 52.

Subsequently, unnecessary portions of the outer circumferences of the passage forming substrate wafer 110 and the protective substrate wafer 130 are cut and removed by dicing, for example. The nozzle plate 20 through which the nozzle openings 21 are punched is joined onto a surface opposite the protective substrate wafer 130 of the passage forming substrate wafer 110, the compliance substrate 40 is joined to the protective substrate wafer 130, and the passage forming substrate wafer 110 is divided into the passage forming substrates 10 having one chip size, as in FIG. 1, to manufacture the ink jet print head.

As described above, the piezoelectric layer 70 of the ink jet print head according to this embodiment is formed by sintering each of the piezoelectric precursor films 74 to form each of the piezoelectric films 75 and by dropping the temperature of each of the piezoelectric films 75 at the temperature drop speed of 25° C./sec or less. That is, since the temperature of the piezoelectric films 75 is not dropped at a rate larger than 25° C./sec, the abnormal stress does not occur in the piezoelectric layer 70 and the satisfactory crystallization of the piezoelectric layer 70 can be obtained.

In this way, since the piezoelectric layer 70 having the satisfactory crystallization can be formed, the piezoelectric element 300 improved in a displacement characteristic or durability can be formed. In addition, by setting the temperature drop speed to about 25° C./sec, it is possible to improve productivity by dropping the temperature as rapid as possible and also improve reliability and the displacement characteristic of the piezoelectric layer 70. In addition, by forming the piezoelectric element 300 in the above-described manner, it is possible to realize the ink jet print head improved in an ink ejection characteristic (liquid ejection characteristic) and reliability.

### Other Embodiments

The embodiment of the invention has been described, but the invention is not limited the embodiment. For example, in the above-described first embodiment, each of the piezoelectric elements 300 is formed by forming the first piezoelectric film 75, patterning the lower electrode film 60 and the first piezoelectric film 75, and sequentially laminating the second and subsequent piezoelectric films 75. However, the patterning may be not performed after the first piezoelectric film 75 is formed. For example, each of the piezoelectric elements 300 may be formed by forming the lower electrode film 60, the piezoelectric layer 70, and the upper electrode film 80 and then patterning them in correspondence with each of the pressure generating chambers 12.

In the above-described first embodiment, the silicon single crystal substrate in which the crystal face orientation is a (110) plane is used as an example of the passage forming substrate 10, but the invention is not particularly limited thereto. For example, a silicon single crystal substrate in which the crystal face orientation is a (100) plane may be used. Alternatively, an SOI substrate or a glass substrate may be used.

In the above-described first embodiment, the ink jet print head is used as an example of the liquid jet head. However, the invention can be broadly applied to various liquid jet heads and thus can be applied to a liquid jet head ejecting a liquid other than ink. Examples of the liquid jet head include various print heads used for an image recording apparatus such as a printer, a color material jet head used to manufacture a color filter such as a liquid crystal display, an electrode material jet head used to form electrodes such as an organic EL display or an FED (Field Emission Display), and a bio organism jet head used to manufacture a bio chip.

The invention is not limited to the method of manufacturing the actuator mounted on the ink jet print head which is a representative example of the liquid jet head, but may be a method of manufacturing an actuator mounted on other apparatuses.

This application claims the benefit of Japanese Patent Application No. 2008-003666, filed 1, 10, 2008. The entire disclosure of the prior application is hereby incorporated by reference herein its entirety.

What is claimed is:

1. A method of manufacturing a liquid jet head which includes a passage forming substrate provided with a pressure generating chamber communicating with a nozzle opening for ejecting a liquid and a piezoelectric element applying pressure to the pressure generating chamber for ejecting the liquid, the method comprising the steps of:
forming a lower electrode above the passage forming substrate;
forming a piezoelectric layer including a plurality of piezoelectric films above f the lower electrode, by repeatedly performing a piezoelectric film forming process of forming a piezoelectric precursor film, which contains a ferroelectric material having a perovskite structure, and sintering to crystallize the piezoelectric precursor film; and
forming an upper electrode above the piezoelectric layer to form a piezoelectric element which includes the lower electrode, the piezoelectric layer, and the upper electrode,
wherein in the step of forming the piezoelectric layer, a temperature of the piezoelectric film is dropped at a temperature drop speed of 25° C./sec or less by 100° C. from a temperature at which the piezoelectric precursor film is sintered, after the piezoelectric precursor film is sintered.

2. The method according to claim 1, wherein in the step of forming the piezoelectric layer, the piezoelectric layer is formed by forming a first piezoelectric film, dropping the temperature of the first piezoelectric film at the temperature drop speed, simultaneously patterning the lower electrode and the first piezoelectric film, and then sequentially laminating the piezoelectric films above the passage forming substrate including the patterned first piezoelectric film.

3. A method of manufacturing an actuator comprising the steps of:
forming a lower electrode above a substrate;
forming a piezoelectric layer including a plurality of piezoelectric films above the lower electrode, by repeatedly performing a piezoelectric film forming process of forming a piezoelectric precursor film, which contains a ferroelectric material having a perovskite structure, and sinter to crystallize the piezoelectric precursor film; and
forming an upper electrode the piezoelectric layer to form a piezoelectric element which includes the lower electrode, the piezoelectric layer, and the upper electrode,
wherein in the step of forming the piezoelectric layer, a temperature of the piezoelectric film is dropped at a temperature drop speed of 25° C./sec or less by 100° C. from a temperature at which the piezoelectric precursor film is sintered, after the piezoelectric precursor film is sintered.
